(19) United States
(12) Patent Application Publication
(10) Pub. No.: US 2016/0221162 A1
(43) Pub. Date: Aug. 4, 2016

(54) WRENCH COMBINING SLEEVE

(71) Applicant: SHANGHAI EASY-USE TOOLS ENTERPRISE CO. LTD, Shanghai (CN)

(72) Inventor: Shiyu Sun, Shanghai (CN)

(21) Appl. No.: 14/917,537

(22) PCT Filed: Sep. 22, 2014
(86) PCT No.: PCT/CN2014/087093

§ 371 Date: Mar. 8, 2016

(30) Foreign Application Priority Data
Aug. 6, 2014 (CN) 2014204412769

(51) Int. Cl. B25B 15/00; B25B 23/12

(52) U.S. Cl. CPC B25B 15/008; B25B 23/12

(57) ABSTRACT

The invention discloses a wrench combining a sleeve. The wrench comprises a wrench body, a rotating sleeve, a locking strip, a hexagonal sleeve and magnetic steel. The wrench is characterized in that the outline of the external circle of the locking strip is of a gradually-opened face structure; a face at which the rotating sleeve is connected to the external circle of the locking strip matches with the gradually-opened face structure, and the two gradually-opened face structures can be mutually locked or released; via the gradually-opened face between the rotating sleeve and the locking strip, the sleeve device is controlled to be fixed on or released from the wrench body and screws are absorbed via the magnetic steel.

### BACKGROUND OF THE INVENTION

1. Field of the Invention

The present invention relates to a wrench technology field, specifically, to a multifunction wrench combining a sleeve.

2. Description of the Related Art

Wrench is a general hardware tool which is utilized widely. Wrench is a tool that is indispensable. It is simple and portable. A contact surface is located between the screws and the wrench, so the stress is sufficient and the wrench is hard to damage. Meanwhile, the wrench is easy to manufacture, and the cost of the wrench is low. However, the present wrench only has single function, each kind of wrench corresponds to a kind of screw.

### SUMMARY OF THE INVENTION

To solve the issue that the wrench only has single function, the invention discloses a multifunction wrench combining a sleeve.

To implement the above purpose, the technical solution of the invention is as follows:
a wrench combining a sleeve, wherein comprises a wrench body, a rotating sleeve, a locking strip, a hexagonal sleeve and magnetic steel;
the locking strip is installed inside the rotating sleeve, the hexagonal sleeve is arranged in the rotating sleeve, and the magnetic steel sleeves one end of the hexagonal sleeve, so a sleeve device is formed, the wrench body penetrates through the sleeve device, wherein the outline of two external circles of the locking strip is of a gradually-opened face structure, a face at which the rotating sleeve is connected to the external circle of the locking strip matches with the gradually-opened face structure, and the two gradually-opened face structures can be mutually locked or released.

The above-mentioned wrench combining a sleeve, wherein a through-hole is arranged in center of the locking strip, the through-hole matches with a structure of an outline of the wrench.

The above-mentioned wrench combining a sleeve, wherein a boss is arranged at one end of the hexagonal sleeve, the boss matches with diameter of an internal circle of the magnetic steel in size.

The above-mentioned wrench combining a sleeve, wherein the outline of the hexagonal sleeve is a circular structure, the circular structure matches with diameter of an internal circle of the rotating sleeve in size.

The above-mentioned wrench combining a sleeve, wherein a step is arranged at bottom of the rotating sleeve, and the locking strip relies onto the step.

Due to the above-mentioned technical, the invention has the following positive effects:
(1) via the gradually-opened face between the rotating sleeve and the locking strip, the sleeve device is controlled to be fixed on or released from the wrench body and screws are absorbed via the magnetic steel.
(2) when the sleeve device slides to a corresponding position on the wrench body, functions of the wrench for operating screws/bolts or inner angle screws/bolts can be achieved and functionality of the wrench is effectively improved.

### BRIEF DESCRIPTIONS OF THE DRAWINGS

FIG. 1 is an explosion diagram of the embodiment of a wrench combining a sleeve according to the present invention;

FIG. 2 is a structure diagram of a wrench combining a sleeve according to the present invention;

FIG. 3 is a section view in A-A section in FIG. 2;

FIG. 4 is a side section view of a wrench combining a sleeve in the Embodiment 1 of the invention;

FIG. 5 is an explosion diagram of a wrench combining a sleeve in the Embodiment 2 of the invention;

FIG. 6 is a section view of a wrench combining a sleeve in the Embodiment 2 of the invention;

FIG. 7 is a structure diagram of a first external sleeve in the Embodiment 2 of the invention;

FIG. 8 is a section view of a first external sleeve in the Embodiment 2 of the invention;

FIG. 9 is a structure diagram of a first internal sleeve in the Embodiment 2 of the invention;

FIG. 10 is an explosion diagram of a wrench combining a sleeve in the Embodiment 3 of the invention;

FIG. 11 is a section view of a wrench combining a sleeve in the Embodiment 3 of the invention;

FIG. 12 is a structure diagram of a second external sleeve in the Embodiment 3 of the invention;

FIG. 13 is a structure diagram of a second internal sleeve in the Embodiment 3 of the invention.

### DETAILED DESCRIPTION

The following description illustrates the invention by combining the drawings and the embodiments, but it can not be limited for the invention.

### Embodiment 1

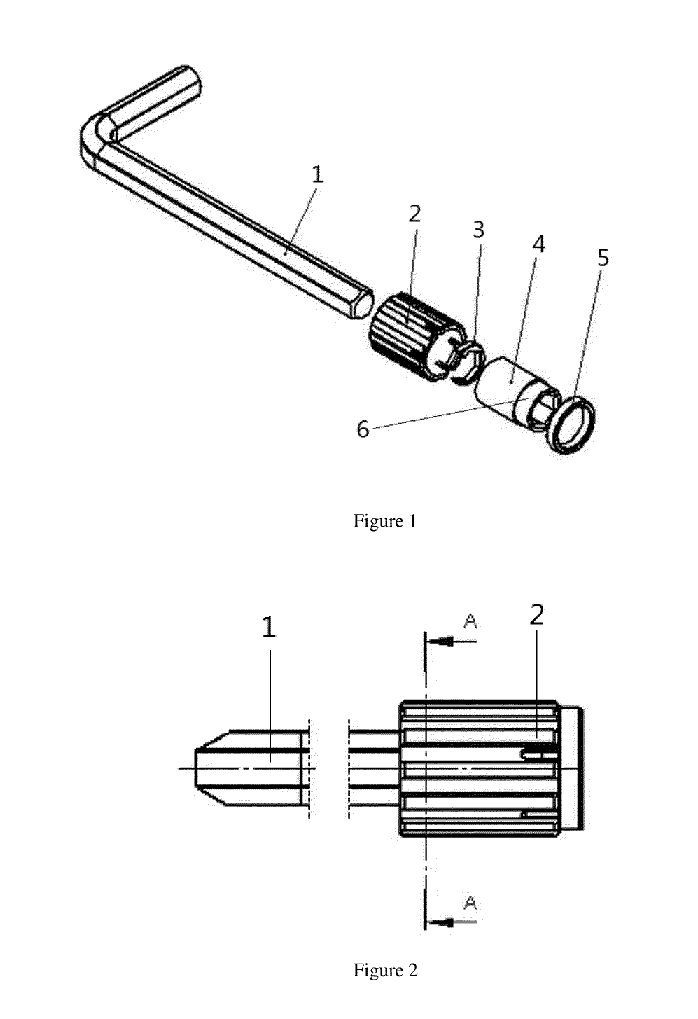

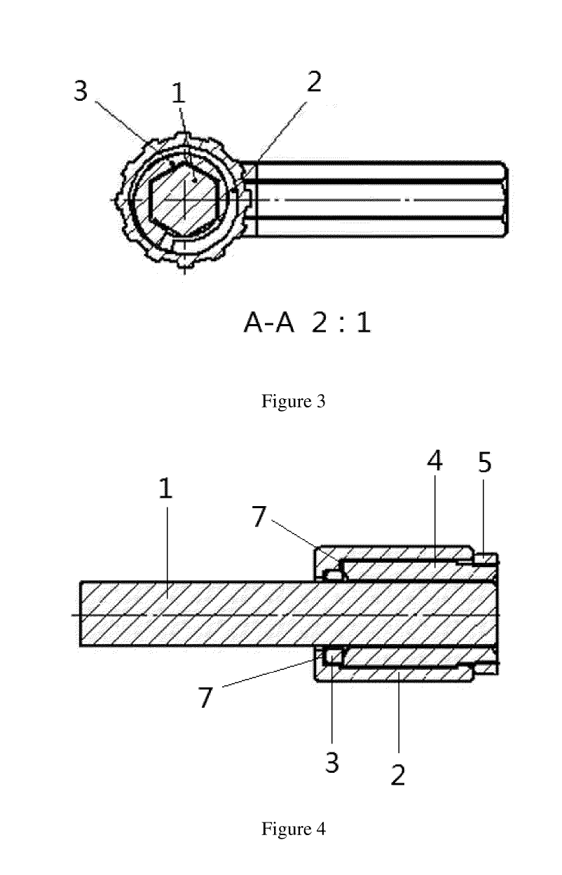

Referring to FIGS. 1 to 4, a wrench combining a sleeve, comprising a wrench body 1, a rotating sleeve 2, a locking strip 3, a hexagonal sleeve 4 and magnetic steel 5:
the locking strip 3 is installed inside the rotating sleeve 2 and at the bottom of the rotating sleeve 2, the hexagonal sleeve 4 is arranged in the rotating sleeve 2 and is arranged on the upper of the rotating sleeve 2, the magnetic steel 5 sleeves one end of the hexagonal sleeve 4, so a sleeve device is formed. On the central of each member which consists of the sleeve device, there is a through-hole structure which has the same structure with a structure of an outline of the wrench body 1, so that the wrench body 1 can penetrate through the sleeve device. Wherein, the outline of two external circles of the locking strip 3 is of a gradually-opened face structure, namely a structure similar to an eccentric circle, a face at which the rotating sleeve 2 is connected to the external circle of the locking strip 3 matches with the gradually-opened face structure, namely a structure similar to an eccentric circle, which is opposite to the structure of the locking strip 3. Therefore the two gradually-opened face structures can be mutually locked or released via the two opposite eccentric circle structures, that is gradually-opened face structure.

Based on above-mentioned context, the invention has the following embodiments, referring to FIG. 1 to FIG. 4.

In a further embodiment, a through-hole is arranged in center of the locking strip 3, the through-hole matches with a structure of an outline of the wrench body 1, so the wrench body 1 can penetrate through the locking strip 3.

In a further embodiment, a boss 6 is arranged at one end of the hexagonal sleeve 4, the size of external circle of the boss 6 is a little less than the size of external circle of the hexagonal sleeve 4, the boss 6 matches with diameter of an internal circle of the magnetic steel 5 in size, so the magnetic steel 5 can sleeve the hexagonal sleeve 4.

In a further embodiment, the outline of the hexagonal sleeve 4 is a circular structure, the circular structure matches with diameter of an internal circle of the rotating sleeve 2 in size, so that the hexagonal sleeve 4 is installed in the rotating sleeve 2 exactly, and is in clearance fit with the rotating sleeve 2.

In a further embodiment, a step 7 is arranged at bottom of the rotating sleeve 2, the locking strip 3 relies onto the step 7.

The user can realize the feature and function of the invention according to the following description.

When the user turns the rotating sleeve 2 anticlockwise, the gradually-opened face structure of the rotating sleeve 2 presses and locks the gradually-opened face structure of the locking strip 3 gradually, as the shape of the through-hole in center of the locking strip 3 matches the internal hexagonal wrench, it is relatively static to the wrench body 1. Therefore, the whole sleeve device part is fixed on the straight bar position of the internal hexagonal wrench body 1. When turning the rotating sleeve 2 clockwise, the gradually-opened face structure of the rotating sleeve 2 releases the gradually-opened face structure of the locking strip 3 gradually, so that the sleeve device can slides on the internal hexagonal wrench body.

Referring to FIG. 4, when the magnetic steel 5 of the sleeve device is partially located on the left side of the right end of the wrench body 1, the wrench body 1 of the invention is suitable for the internal hexagonal screw; on the contrary, when the magnetic steel 5 of the sleeve device is partially located on the right side of the right end of the wrench body 1, the wrench body 1 of the invention is suitable for the external hexagonal bolt, that is bolt. Other than the general wrench corresponding to one screw, the wrench is flexible and has widely range for usage.

### Embodiment 2

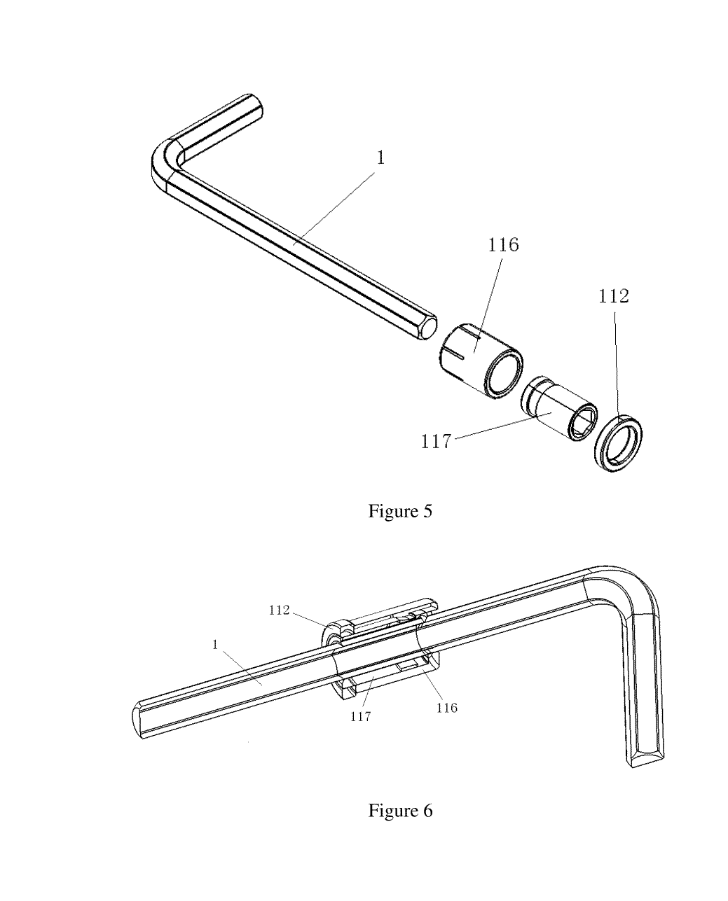

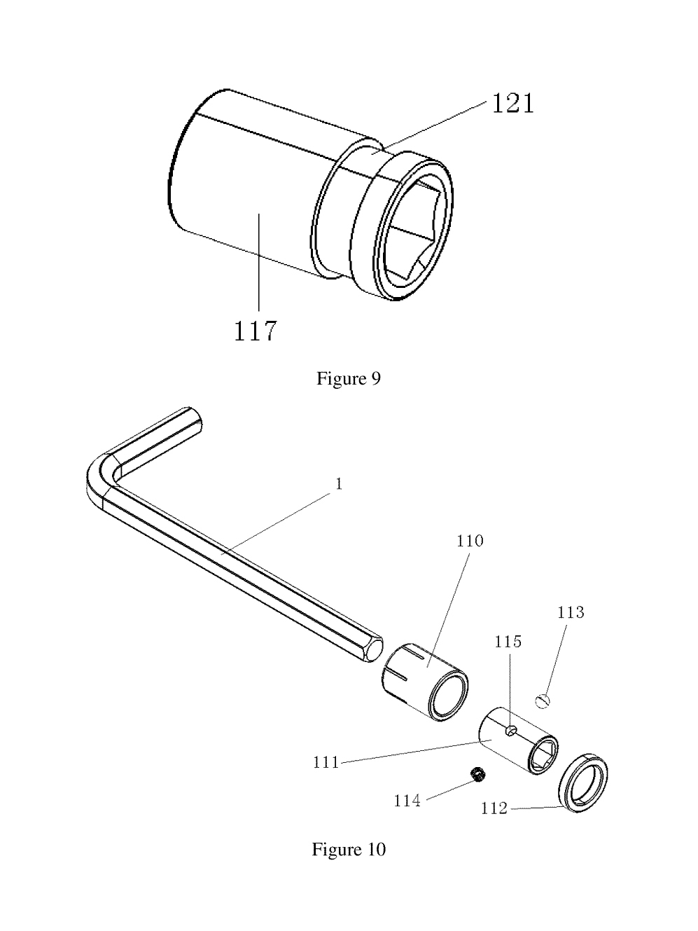

Referring to FIGS. 5 to 9, a second kind of wrench combining a sleeve of the invention, comprising a wrench body 1 and a sleeve device.

In Embodiment 2, the sleeve device includes a first internal sleeve 117, a first external sleeve 116 and a magnet ring 112. The magnet ring 112 and the first internal sleeve 117 are in interference fit with each other, the first external sleeve 116 sleeves the first internal sleeve 117, a ring slot 121 is arranged on the first internal sleeve 117, a lug 119 matching the ring slot 121 is arranged in the internal circle of the first external sleeve 116. The first internal sleeve 117 fits the first external sleeve 116 and it can sleeve on any end of the wrench body 1 slidably. The first internal sleeve 117 and the first external sleeve 116 can be in interference fit with the wrench body 1.

In a further embodiment, a plurality of claws 120 are arranged on the first external sleeve 116, relative to one end of the magnet ring 112. The plurality of claws 120 contact the corresponding surfaces of the wrench body 1 respectively.

In a further embodiment, a plurality of bar grooves 122, relative to one end of the external circle of the magnet ring 112, are arranged on the first external sleeve 116.

In a further embodiment, a plurality of bar grooves 122 are spaced apart and are arranged on the first external sleeve 116.

The user can realize the feature and function of the invention according to the following description.

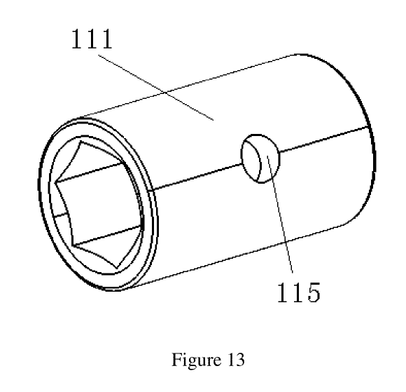

Referring to FIGS. 1 to 5, in the first solution of the embodiment, a wrench combining a sleeve, the first external sleeve 116 sleeves the first internal sleeve 117, a ring slot 121 is arranged on the first internal sleeve 117 (see FIG. 13), a lug 119 is arranged on the first external sleeve 116 fitting with ring slot 121 (see FIG. 12), the first external sleeve 116 and the first internal sleeve 117 are in fit with the lug 119 by the ring slot 121, the magnet ring 112 is in interference fit with the first internal sleeve 117, so that the magnet ring 112 fixes on the first internal sleeve 117 firmly. When the first external sleeve 116 sleeves on the first internal sleeve 117, the lower end of the first external sleeve 116 relies on the magnet ring 112. The diameter of the first external sleeve 116, relative to the three claws of the one end of the magnet ring 112, is less than the diameter of the wrench body 1, so that the first external sleeve 116 can contact the corresponding surface of the wrench tightly, thus the sleeve device sleeves the wrench firmly without falling. The sleeve device can sleeve any one of the two ends of the wrench, so that different requirements are met. When the sleeve device is located on any end of the two ends, it is suitable for the hexagonal screw. When the sleeve device is located on the middle of the two ends, it is suitable for the internal hexagonal screw. Wherein, the magnet ring 112 is configured to absorb the screws.

### Embodiment 3

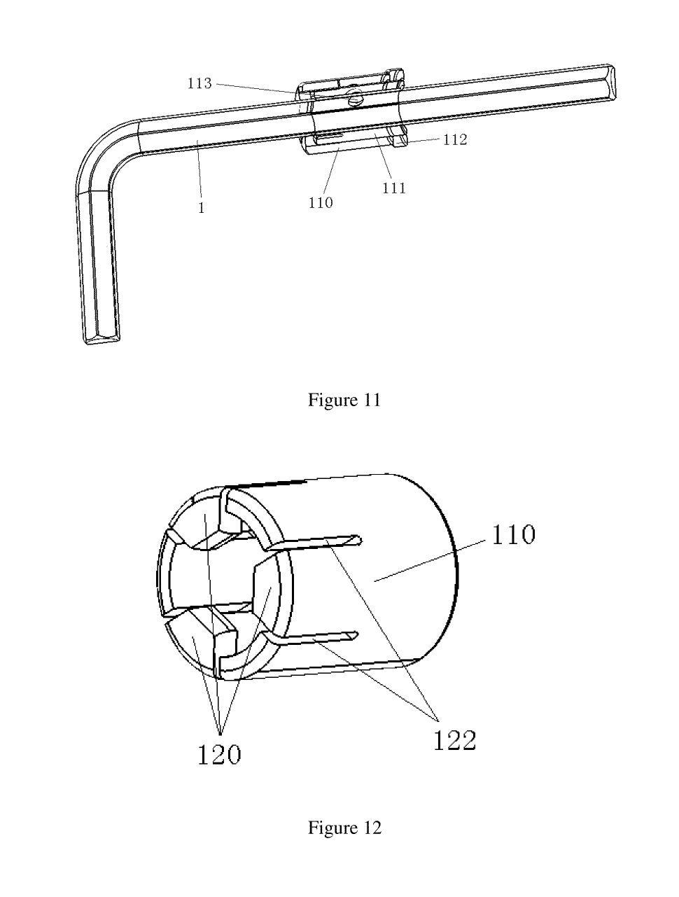

Referring to FIGS. 10 to 13, a third kind of wrench combining a sleeve of the invention, comprising a wrench body 1 and a sleeve device. The sleeve device detachably sleeves any end of the wrench body 1.

In Embodiment 3, the sleeve device includes a second external sleeve 110, a second internal sleeve 111, a magnet ring 112, a steel ball 113 and a spring 114. The magnet ring 112 and the second internal sleeve 111 are in interference fit with each other, the second external sleeve 110 sleeves the second internal sleeve 111, a hole is arranged on the second internal sleeve 111, the steel ball 113 is installed in the round through-hole 115. The spring 114 is connected to the steel ball 113, the steel ball 113 and the spring 114 are in fit within the round through-hole 115, and they are located between the second external sleeve 110 and the second internal sleeve 111. The diameter of the round through-hole 115 is less than the diameter of the steel ball 113, so that the steel ball 113 cannot penetrate through the round through-hole 115. The gap between the second external sleeve 110 and the second internal sleeve 111 makes the spring 114 compressed, the elastic force is generated and the part of the steel ball 113 contacts the surface of the wrench body tightly.

In a further embodiment, a plurality of bar grooves 122, relative to one end of the external circle of the magnet ring 112, are arranged on the second external sleeve 110.

In a further embodiment, a plurality of bar grooves 122 are spaced apart and are arranged on the second external sleeve 110.

In a further embodiment, the diameter of the round through-hole 115 is less than the diameter of the steel ball 113.

The user can realize the feature and function of the invention according to the following description.

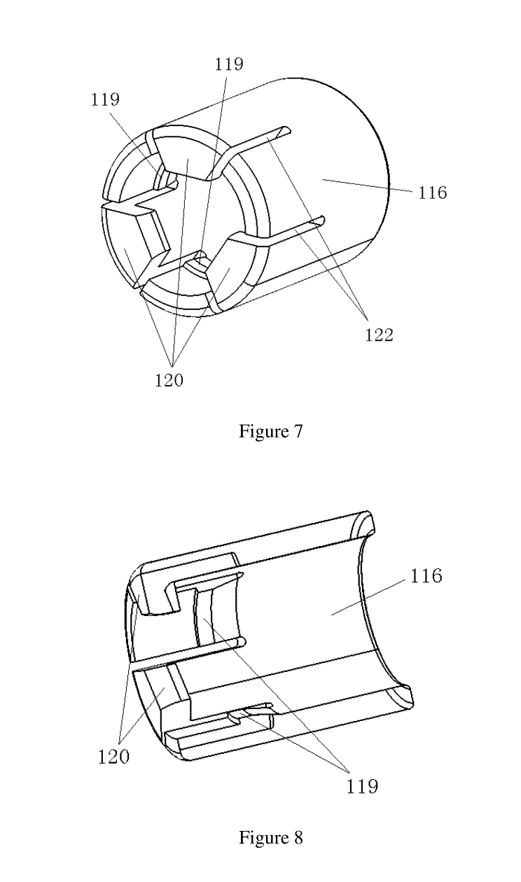

Referring to FIGS. 6 to 9, in a second solution of the embodiment, the second external sleeve 110 sleeves the second internal sleeve 111, a round through-hole 115 is arranged on the second internal sleeve 111. The diameter of the round through-hole 115 is less than the diameter of the steel ball 113, so that the steel ball 113 cannot penetrate through the round through-hole 115. The spring 114 and the steel ball 113 are in fit within the round through-hole 115, and they are located between the second external sleeve 110 and the second internal sleeve 111. As the gap between the second external sleeve 110 and the second internal sleeve 111 is small, so the spring 114 has a space to be compressed. The spring 114 presses the steel ball 113, so that the steel ball 113 contacts the surface of the wrench body firmly by the round through-hole 115. The sleeve device can also connect to the wrench body tightly when the wrench body expands or contracts. The magnet ring 112 is in interference fit with the second internal sleeve 111, so that the magnet ring 112 fixes on the second internal sleeve 111 firmly. When second external sleeve 110 sleeves on the second internal sleeve 111, the lower end of the second external sleeve 110 relies on the magnet ring 112. The diameter of the second external sleeve 110, relative to the three claws of the one end of the magnet ring 112, is less than the diameter of the wrench body 1, so that the second external sleeve 110 can contact the corresponding surface of the wrench tightly, thus the sleeve device sleeves the wrench firmly without falling. The sleeve device can sleeve any one of the two ends of the wrench, so that different requirements are met. When the sleeve device is located on any end of the two ends, it is suitable for the hexagonal screw. When the sleeve device is located on the middle of the two ends, it is suitable for the internal hexagonal screw. Wherein, the magnet ring 112 is configured to absorb the screws.

The description listed above is the preferred embodiments, it can not limit the manner or protect scope of the invention. It should be understood that the changes and modifications can be made without departing from the spirit and scope of the present disclosure and are in the scope of the invention.

What is claimed is:

1. A wrench combining a sleeve, comprising a wrench body, a rotating sleeve, a locking strip, a hexagonal sleeve and magnetic steel;
wherein, the locking strip is installed inside the rotating sleeve, the hexagonal sleeve is arranged in the rotating sleeve, and the magnetic steel sleeves one end of the hexagonal sleeve, so a sleeve device is formed, the wrench body penetrates through the sleeve device; the outline of two external circles of the locking strip is of a gradually-opened face structure, a face at which the rotating sleeve is connected to the external circle of the locking strip matches with the gradually-opened face structure, and the two gradually-opened face structures can be mutually locked or released.

2. The wrench combining a sleeve as disclosed in claim 1, wherein a through-hole is arranged in center of the locking strip, the through-hole matches with a structure of an outline of the wrench.

3. The wrench combining a sleeve as disclosed in claim 1, wherein a boss is arranged at one end of the hexagonal sleeve, the boss matches with diameter of an internal circle of the magnetic steel in size.

4. The wrench combining a sleeve as disclosed in claim 1, wherein the outline of the hexagonal sleeve is a circular structure, the circular structure matches with diameter of an internal circle of the rotating sleeve in size.

5. The wrench combining a sleeve as disclosed in claim 1, wherein a step is arranged at bottom of the rotating sleeve, and the locking strip relies onto the step.
